(19) United States
(12) Patent Application Publication
(10) Pub. No.: US 2017/0280759 A1
(43) Pub. Date: Oct. 5, 2017

(54) Food Condiment

(71) Applicant: Larry Kellum, JR., Newport News, VA (US)

(72) Inventor: Larry Kellum, JR., Newport News, VA (US)

(21) Appl. No.: 15/086,466

(22) Filed: Mar. 31, 2016

(51) Int. Cl. A23L 27/60; A23L 27/18; A23L 27/00; A23L 27/40; A23L 27/50

(52) U.S. Cl. CPC A23L 27/63; A23L 27/60; A23L 27/40; A23L 27/50; A23L 27/80; A23L 27/18; A23V 2002/00

(57) ABSTRACT

A food condiment and method of preparing such condiment is provided. The food condiment may be used as salad dressings, marinades, dipping sauces, and the like. The food condiment includes mayonnaise, ketchup, mustard, pepper, crab seasoning, dried parsley; spice seasoning, salt, soy sauce, and hot sauce. The ingredients may be intermixed in a variety of mixing orders. In one intermixing method, the oil based ingredients and the water based ingredient are mixed with an emulsifier to create a stable emulsion at room temperature.

### FIELD OF THE INVENTION

The present invention relates to the field of food products. More specifically, the present invention relates to a recipe and process of making a food condiment that is a blend of natural and healthy ingredient.

### BACKGROUND OF THE INVENTION

Various food condiments are used as salad dressings, marinades, dipping sauces, and the like. In addition, various techniques for preparing such condiments for these purposes and for adding flavor to food. However, a substantial amount of these available salad dressings and dipping sauces have similar generic tastes and textures that limit consumers' choices.

In general, there are two basic salad dressings and dipping sauces: vinaigrette and creamy dressings. Vinaigrettes typically include a mixture or emulsion of oil and vinegar flavored with other ingredients. Creamy dressings may contain mayonnaise, but may also contain yogurt, sour cream, buttermilk, or milk. These basic mixtures are most often used as a salad dressing, a marinade, or dipping sauce for vegetables and chips. Some of these popular mixtures include ranch dressing and caesar dressing which may be considers bland or tasteless by many, requiring the use of substantially more than standard portion size. This, in turn, leads to an excess consumption of calories and artificial ingredients that, in sufficient quantity, may be deemed unhealthy. Yet others, may find these dressings as overpowering the original taste of the food. Therefore a need exists for new ways to improve the taste of salad dressings and dipping sauces in order to promote the consumption and appropriate portioning of salads, vegetables, and other foods.

### SUMMARY OF THE INVENTION

In view of the foregoing disadvantages inherent in the known types of food condiments now present in the prior art, the present invention provides a new food condiment wherein the same can be utilized for providing a salad dressings, marinades, dipping sauces, and the like.

The present invention relates to a food condiment comprising the following elements mayonnaise, ketchup, mustard, pepper, crab seasoning (such as OLD BAY Seasoning), dried parsley; spice seasoning (such as CAVENDER'S Greek Seasoning), salt, soy sauce, and hot sauce (such as TEXAS PETE Hot Sauce). In one process of making the condiment, the elements may be mixed until the mixture is approximately uniform in color and texture. The condiment may be used as a flavor enhancer.

It is therefore an object of the present invention to provide a n a food condiment that has all of the advantages of the prior art and none of the disadvantages.

It is therefore an object of the present invention to provide a food condiment that improves the flavor of foods.

It is therefore an object of the present invention to provide a food condiment that is an emulsion, such that it is suitable for human consumption.

Other objects, features and advantages of the present invention will become apparent from the following detailed description.

### DETAILED DESCRIPTION OF THE INVENTION

Although the characteristic features of this invention will be particularly pointed out in the claims, the invention itself and manner in which it may be made and used may be better understood after a review of the following description. For the purposes of presenting a brief and clear description of the present invention, the preferred embodiment will be discussed as used for flavor enhancing. The examples are intended for representative purposes only and should not be considered to be limiting in any respect.

As used herein, “emulsifier” refers to (i) a surface active component or (ii) a component mixture that reduces the interfacial tension between oil and aqueous ingredients. However, this should not be read as limiting in any way as the present disclosure contemplates embodiments of the present invention utilizing various orders of intermixing the ingredients.

The invention relates to an improves food condiment. The food condiment in accordance with the principles of the invention is provided in predetermined volume quantities including, but not limited to, a mixture of mayonnaise, ketchup, mustard, pepper, crab seasoning (such as OLD BAY Seasoning), dried parsley, spice seasoning (CAVENDER'S Greek Seasoning), salt, soy sauce, and hot sauce (TEXAS PETE Hot Sauce).

The food condiment in accordance with the present invention contains on volume basis approximately 45.88% mayonnaise, 34.41% ketchup, 2.87% mustard, 0.72% pepper, 0.72% crab seasoning, 2.87% dried parsley, 0.72% spice seasoning, 0.36% salt, 5.73% soy sauce, and 5.73% hot sauce. The quantities given for a one embodiment of a mixture, but may be varies according to the desired flavor and end product. The proportions given are relative to each other and if carrying the total quantity of the finished product, one must be aware of the necessity to increase or decrease each ingredient proportionally. It should be noted that the steps of intermixing can be carried out in many different orders according the user preference.

In accordance with the embodiments of the present invention one method of use is discloses herein for preparing the food condiment including a first step of intermixing all of the listed ingredients with moderate agitation until the present invention becomes approximately uniform in color and texture. The mixture can then be cooled to about 40 degrees Fahrenheit and stored in a container until needed.

Another method of use is discloses herein for preparing the food condiment including a first step of intermixing one cup of mayonnaise, ¾ cup of ketchup, two tablespoon of soy sauce, and two tablespoon of hot sauce to form a wet mixture. A second step of intermixing mixing ¼ tablespoon of pepper, ¼ tablespoon of crab seasoning, one tablespoon of dried parsley, ¼ tablespoon of spice seasoning, ⅛ tablespoon of salt to form a dry mixture. A third step of intermixing the wet mixture and the dry mixture to form an emulsion. The end product may be added to at least one salad, added as a marinade to a meat or other foodstuff, or used as a dipping sauce for a crudites that includes chips and vegetables.

Yet another method of use is discloses herein for preparing the food condiment including a first step of intermixing oil soluble ingredients, such as mayonnaise, and a second step of intermixing water soluble ingredients, such as soy sauce. A third step of intermixing the oil soluble ingredients and the water soluble ingredients with an emulsifier, such as mustard, to create a stable emulsion at room temperature.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum volumetric and proportional relationships for the parts of the invention, to include variations in weight, volume, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A food condiment consisting essentially of:
45.88% by weight of mayonnaise;
34.41% by weight of ketchup;
2.87% by weight of mustard;
0.72% by weight of pepper;
0.72% by weight of crab seasoning;
2.87% by weight of dried parsley;
0.72% by weight of spice seasoning;
0.36% by weight of salt;
5.73% by weight of soy sauce;
5.73% by weight of hot sauce.

2) (canceled)

3) The process of producing the food condiment of claim 1 comprising the steps of:
intermixing the mayonnaise, ketchup, mustard, pepper, crab seasoning, dried parsley,
spice seasoning, salt,
soy sauce, and hot sauce.

4) A food condiment consisting essentially of:
one cup of mayonnaise;
¾ cup of ketchup;
one tablespoon of mustard;
¼ tablespoon of pepper;
¼ tablespoon of crab seasoning;
one tablespoon of dried parsley;
¼ tablespoon of spice seasoning;
⅛ tablespoon of salt;
two tablespoon of soy sauce;
two tablespoon of hot sauce.

5) The process of producing the food condiment of claim 4 comprising the steps of:
intermixing the mayonnaise, the ketchup, the mustard, the pepper, the crab seasoning, the dried parsley, the spice seasoning, the salt, the soy sauce, and the hot sauce.

6) A process of producing food condiment of claim 4 comprising the steps of:
mixing the mayonnaise, the ketchup, the soy sauce, and the hot sauce to form a wet mixture;
mixing the pepper, the crab seasoning, the dried parsley, the spice seasoning, and the salt to form a dry mixture;
mixing the wet mixture and the dry mixture with the mustard to form an emulsion.
